(19) United States
(12) Patent Application Publication
(10) Pub. No.: US 2007/0194159 A1
(43) Pub. Date: Aug. 23, 2007

(54) WATER FLOW MONITOR AND CONTROL DEVICE FOR FOOD WASTE DISPOSER

(75) Inventors: Thomas R. BERGER, Racine, WI (US); Steven P. HANSON, Racine, WI (US)

Correspondence Address: HARNESS, DICKEY & PIERCE, P.L.C., P.O. BOX 828, BLOOMFIELD HILLS, MI, 48303, US

(73) Assignee: EMERSON ELECTRIC CO., St. Louis, MO (US)

(21) Appl. No.: 11/307,771

(22) Filed: Feb. 21, 2006

(51) Int. Cl. B02C 23/36

(52) U.S. Cl. 241/36; 241/46.013

(57) ABSTRACT

A food waste disposer system includes a housing with a grinding mechanism situated in the housing for reducing food waste. A motor drives the grinding mechanism. An outlet receives the reduced food waste from the grinding mechanism to discharge the food waste from the disposer housing. A water flow detector senses water flow through the disposer, and the disposer motor is controlled in response to the sensed water flow through the disposer.

### BACKGROUND

The present disclosure relates generally to food waste disposers.

Food waste disposers are used to comminute food scraps into particles small enough to safely pass through household drain plumbing. A conventional disposer includes grinding mechanism that is driven by a motor. The grinding mechanism is situated in a housing that forms an inlet connected to a sink drain opening for receiving food waste and water. The grind mechanism typically includes a rotating shredder plate with lugs and a stationary grind ring attached to the inside of the housing.

In operation of the disposer, a user puts the food waste into the inlet, and activates the motor. The motor turns the rotating shredder plate and the lugs force the food waste against the grind ring where it is broken down into small pieces. In a typical kitchen application, the kitchen faucet is opened so that water runs into the disposer inlet to rinse and carry the food waste through the grind mechanism during the grinding operation. Once the particles are small enough to pass out of the grinding mechanism, they are flushed out into the household plumbing along with the water running into the grinding mechanism.

Insufficient water flow through the disposer during the grinding process can result in less than optimal performance. Waste particles can adhere to the surfaces of the grind mechanism components and to the interior of the grind section housing. Inadequate rinsing can cause food build up and odor to occur. This can result in odors and even reduced grind performance, and can also result in blockages of downstream plumbing. Further, excessive water flow through the disposer is wasteful.

The present application addresses shortcomings associated with the prior art.

### SUMMARY

A food waste disposer system includes a housing with a grinding mechanism situated in the housing for reducing food waste. A motor drives the grinding mechanism. An outlet receives the reduced food waste from the grinding mechanism to discharge the food waste from the disposer housing. A water flow detector is situated to sense water flow through the housing.

In exemplary embodiments, the water flow detector includes a processor that determines the water flow rate through the outlet. In accordance with further aspects of the disclosure, the water flow detector includes a sense capacitor, and the processor measures the capacitance of the sense capacitor to determine water flow. Various methods of calculating the capacitance, and thus the water flow rate, are disclosed herein. For example, the rate at which the sense capacitor charges and/or discharges is determined. A larger capacitance will result in correspondingly longer charge and discharge rates. In still further exemplary embodiments, the frequency of an oscillator connected to the sense capacitor is monitored to determine capacitance.

In certain implementations, the water flow detector is connected to the disposer's drain pipe, which receives water from the disposer outlet. Two conductive plates are situated opposite one another on the drain pipe to form the sense capacitor, wherein the capacitance varies in response to water flow through the drain pipe, and thus between the plates of the sense capacitor. To provide optimum operation of the disposer and conserve water, the disposer motor is controlled in response to the sensed water flow through the disposer. For example, the disposer's motor is not turned on until adequate water flow is sensed, and the motor is turned off if excessive water flow is detected.

### BRIEF DESCRIPTION OF THE DRAWINGS

Other objects and advantages of the invention will become apparent upon reading the following detailed description and upon reference to the drawings in which:

FIG. 1 is a sectional view of a food waste disposer system embodying certain aspects of the present disclosure.

FIG. 2 is a schematic diagram illustrating a water flow detector circuit in accordance with the teachings of the present disclosure.

FIG. 3 is a schematic diagram illustrating another water flow detector circuit in accordance with the teachings of the present disclosure.

FIG. 4 is a schematic diagram illustrating a further water flow detector circuit in accordance with the teachings of the present disclosure.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention.

### DETAILED DESCRIPTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

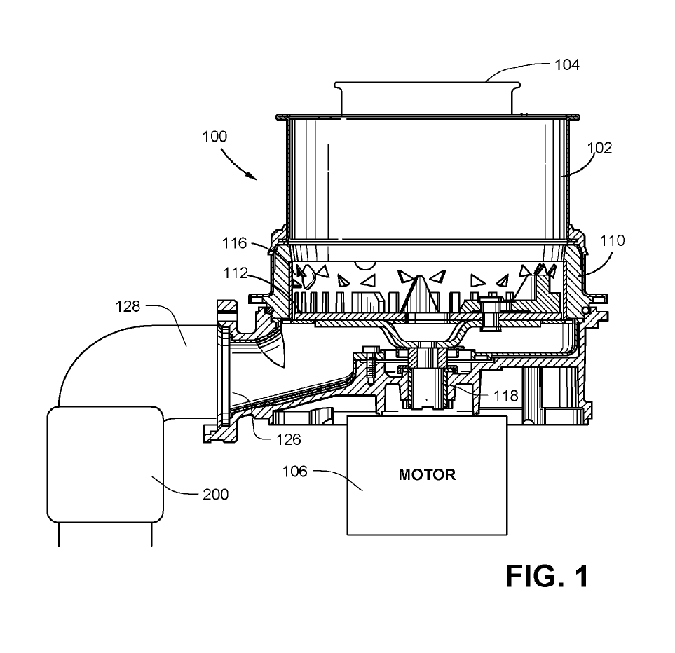

FIG. 1 illustrates portions of an exemplary food waste disposer system in accordance with the teachings of the present disclosure. The food waste disposer 100 includes a grinding mechanism 110 that is situated in a housing 102. The housing 102 defines an inlet 104 that is in communication with a sink drain for receiving food waste and water, which is conveyed to the grinding mechanism 110. The grinding mechanism 110 includes a stationary grind ring 116 that is fixedly attached to an inner surface of the housing 102. A motor 106 imparts rotational movement to a motor shaft 118, which turns a rotating shredder plate assembly 112 relative to the stationary grind ring 116 to reduce food waste to small pieces. When the food waste is reduced to particulate matter sufficiently small, it passes from above the shredder plate assembly 112, and along with water introduced into the disposer, is discharged through a discharge outlet 126.

A water flow detector 200 senses water flow through the disposer 100. In the exemplary system 100 illustrated in FIG. 1, the water flow detector 200 is connected to a drain pipe 128, which is connected to the outlet 126. Two conductive plates are situated on the drain pipe in an opposing relationship to form a sense capacitor. In certain implementations, the plates are copper plates, with one plate measuring about 1×1 inch, and the other measuring about 1×2 inches. The plates can be built into the drain pipe 128, or can be part of a water flow detector module that removably fits over the drain pipe 128. In certain embodiments, each copper plate has a watertight wire with a plug attached thereto. The flow detector 200 is powered by a low voltage, for example, about 5 volts, and may be wired into the disposer's power supply line supply or be powered by an alternative supply.

In general, a capacitor with water between the plates has more capacitance than a capacitor with air between the plates, assuming the distance between the plates remains constant. With greater water flow, more space between the capacitor's plates is filled with water rather than air. Measuring the capacitance gives an indication of the amount of water flowing through the drain pipe 128, and thus the disposer 100.

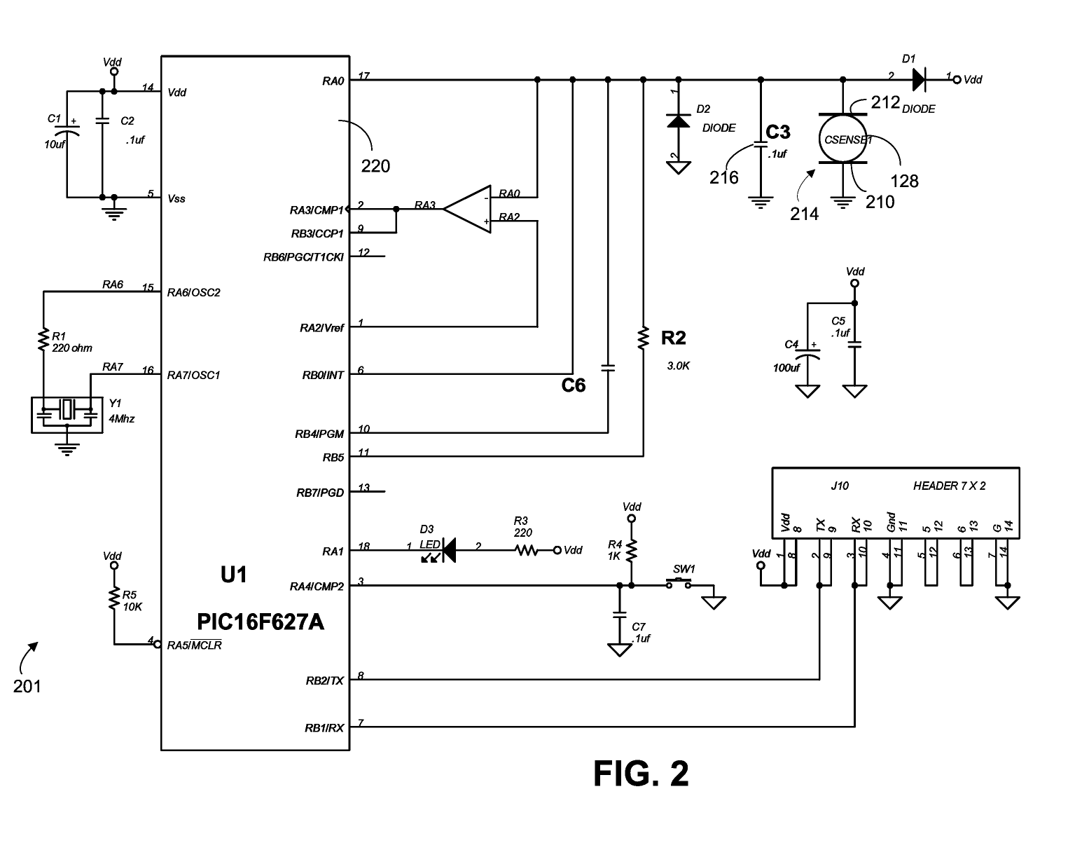

FIG. 2 illustrates an exemplary water flow detector circuit 201. The first and second conductive plates 210, 212 are positioned on opposite sides of the drain pipe 128 to form a sense capacitor 214, with one plate 210 grounded and the other connected to a processor 220. In the various circuits disclosed herein, a model PICi 6F627A microcontroller available from Microchip Technology Inc. of Chandler, Ariz., is a suitable processor. The sense capacitor 214 formed by the plates 210, 212 around the pipe 128 has a relatively small capacitance that can be difficult to measure. In the circuit 201, an electrical charge is placed in the sense capacitor 214 and then transferred to a holding capacitor 216 that can hold a larger charge. The number of times the sense capacitor 214 is filled and transferred to the holding capacitor 216 in order to charge the holding capacitor 216 is a measure of the size of the sense capacitor 214, which reflects the water flow.

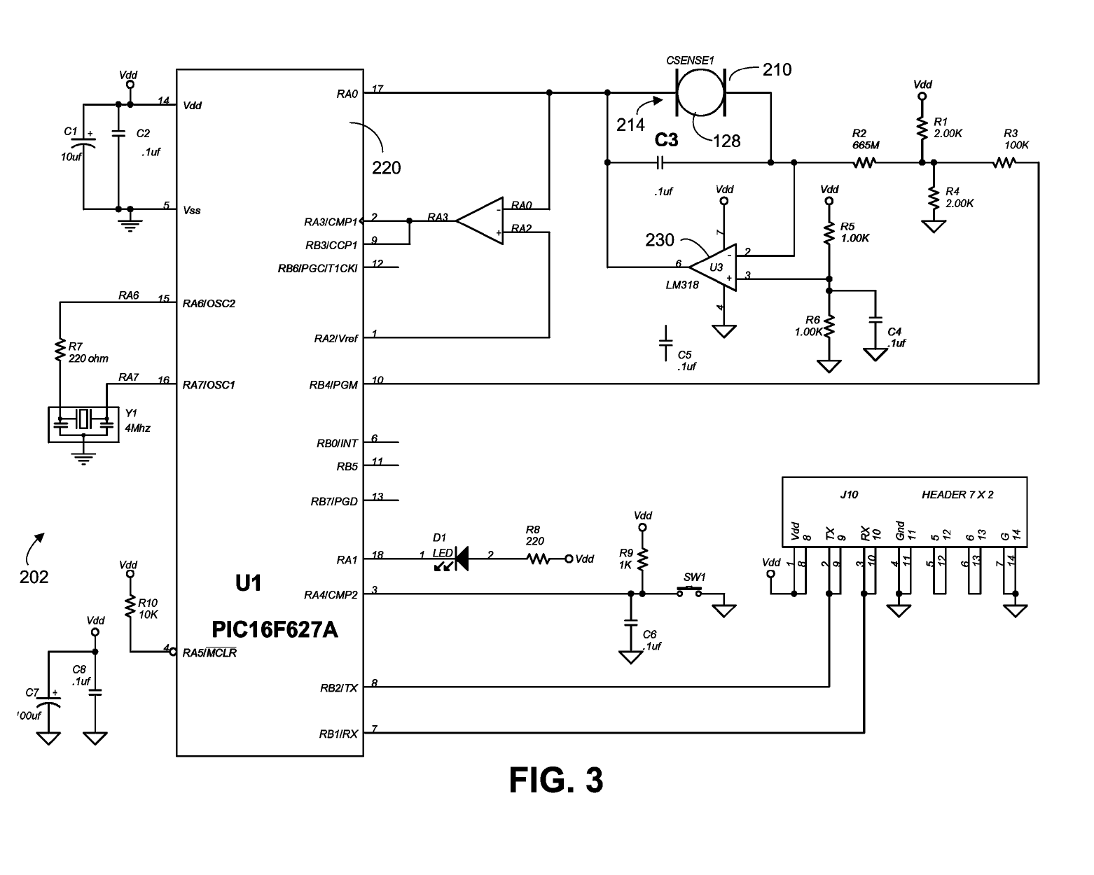

FIG. 3 illustrates a water flow detector circuit 202 in accordance with another embodiment of the water flow detector 200. To determine the capacitance of the sense capacitor, the rate at which the sense capacitor charges and/or discharges is measured. An amplifier 230 configured as an integrator is connected to the sense capacitor 214 and the processor 220. In the circuit 202, the sense capacitor 214 slows the reaction of the amplifier 230 to a voltage change at the amplifier input. The larger the capacitor, the longer it takes the output of the amplifier 230 to change from a low voltage to a high voltage or to change back from a high voltage to the low voltage. The processor 220 receives signals from the amplifier 230 and measures the rising slope (low-voltage to high-voltage) and then the falling slope. Many of the errors from the rising slope are cancelled by opposite errors from the falling slope.

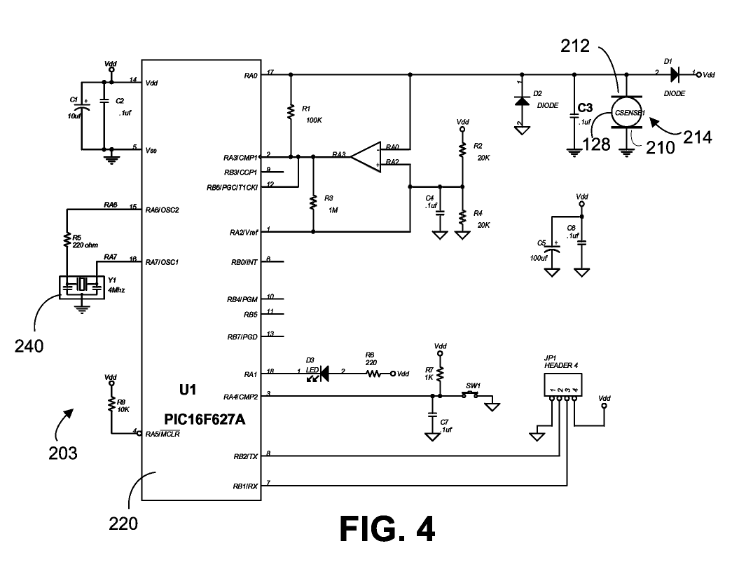

FIG. 4 illustrates another water flow detector circuit 203 in accordance with a further embodiment of the water flow detector 200. In the circuit 203, the sense capacitor 214 controls the frequency of an oscillator 240. The larger the capacitor, the lower the frequency. The processor 220 measures the frequency by counting the number of cycles in a set period of time—the lower the count, the higher the capacitance. Thus, a lower frequency indicates more water flow.

There are a variety of factors that can change the capacitance of the sense capacitor 214 in addition to the amount of water flow. If grease or minerals in the drain pipe 128 change the capacitance readings, the processor 220 can be programmed to recalibrate to compensate for such other factors. If electrical noise (such as from the motor 106) causes erroneous readings, determining the capacitance several times and then averaging the result may compensate. In exemplary embodiments, capacitance is measured and updated twice per second.

The processor 200 is further connected to the motor 106 or a motor controller in some embodiments, allowing control of the disposer motor 106 in response to the measured water flow. For example, the processor 220 signals the motor 106 to turn on only if the water flow exceeds a predetermined amount, such as 1.5 GPM. Further, to conserve water, the processor 220 can signal the motor to turn off if excessive water flow is determined, such as flow greater than 2.2 GPM. In still further embodiments, water flow must be detected for a predetermined time period (three seconds, for example) before the processor 220 signals the motor 106 to start. An override is provided in situations where a user wishes to operate the disposer 100 independent of the water flow measurements.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A food waste disposer system, comprising:
a housing;
a grinding mechanism situated in the housing for reducing food waste;
a motor operably connected to the grinding mechanism;
an outlet receiving the reduced food waste from the grinding mechanism for discharging the food waste from the housing; and
a water flow detector situated to sense water flow through the housing.

2. The food waste disposer system of claim 1, wherein the water flow detector includes a processor that determines water flow rate through the housing.

3. The food waste disposer of claim 2, wherein the water flow detector includes a sense capacitor, wherein the processor measures capacitance of the sense capacitor to determine water flow.

4. The food waste disposer system of claim 3, wherein the processor monitors the rate at which the sense capacitor charges.

5. The food waste disposer system of claim 3, wherein the processor monitors the rate at which the sense capacitor discharges.

6. The food waste disposer system of claim 3, further comprising an oscillator coupled to the sense capacitor and the processor, wherein the processor measures the frequency of the oscillator to determine the capacitance of the sense capacitor.

7. The food waste disposer system of claim 3, wherein the processor calculates an average capacitance of the sense capacitor.

8. The food waste disposer system of claim 3, further comprising a drain pipe attached to the outlet, wherein the water flow detector is connected to the drain pipe.

9. The food waste disposer system of claim 8, further comprising first and second conductive plates situated on opposing sides of the drain pipe to form the sense capacitor, wherein the capacitance varies in response to water flow through the drain pipe.

10. The food waste disposer system of claim 1, further comprising a control device controlling the motor in response to the water flow detector.

11. The food waste disposer system of claim 10, wherein the control device turns on the motor when the water flow rate is within a predetermined range.

12. The food waste disposer system of claim 10, wherein the control device turns on the motor when the water flow rate is above a predetermined value.

13. The food waste disposer system of claim 10, wherein the control device turns off the motor when the water flow rate is below a predetermined value.

14. A control system for a food waste disposer, comprising:
a water flow detector for sensing water flow through the disposer; and
a control device for controlling operation of the disposer in response to the water flow detector.

15. The control system of claim 14, wherein the water flow detector includes a sense capacitor, and wherein the control device includes a processor that measures capacitance of the sense capacitor to determine water flow.

16. The control device of claim 15, wherein the processor monitors the rate at which the sense capacitor charges to determine the capacitance of the sense capacitor.

17. The control device of claim 15, wherein the processor monitors the rate at which the sense capacitor discharges to determine the capacitance of the sense capacitor.

18. The control device of claim 15, further comprising an oscillator coupled to the sense capacitor and the processor, wherein the processor measures the frequency of the oscillator to determine the capacitance of the sense capacitor.

19. The control device of claim 15, wherein the processor calculates an average capacitance of the sense capacitor.

20. The control device of claim 15, wherein the sense capacitor comprises first and second conductive plates positionable on opposing sides of a drain pipe connected to an outlet of the disposer.

21. A method of operating a food waste disposer, comprising:
measuring water flow through the disposer; and
controlling a grinding mechanism of the disposer in response to the measured water flow.

22. The method of claim 21, wherein measuring water flow includes determining capacitance of a sense capacitor positioned such that the capacitance varies in response to the water flow.

23. The method of claim 22, wherein determining capacitance includes measuring a rate at which the sense capacitor charges.

24. The method of claim 22, wherein determining capacitance includes measuring a rate at which the sense capacitor discharges.

25. The method of claim 22, wherein determining capacitance includes measuring the frequency of an oscillator connected to the sense capacitor.

26. The method of claim 22, wherein determining water flow includes positioning first and second plates of the sense capacitor capacitance on a drain pipe attached to the outlet.

27. The method of claim 21, wherein controlling the grinding mechanism includes turning on a motor driving the grinding mechanism when the water flow rate is within a predetermined range.

28. The method of claim 21, wherein controlling the grinding mechanism includes turning on a motor driving the grinding mechanism when the water flow rate is above a predetermined value.

29. The method of claim 21, wherein controlling the grinding mechanism includes turning on a motor driving the grinding mechanism when the water flow rate is below a predetermined value.
